(19) United States
(12) Patent Application Publication
(10) Pub. No.: US 2013/0257633 A1
(43) Pub. Date: Oct. 3, 2013

(54) METHOD FOR KEYBOARD SCANNING AND A KEYBOARD APPLYING THE SAME

(71) Applicants: LITE-ON ELECTRONICS (GUANGZHOU) LIMITED, GUANGZHOU (CN); LITE-ON TECHNOLOGY CORP., TAIPEI (TW)

(72) Inventor: CHIEN-CHIH CHEN, TAIPEI (TW)

(73) Assignees: LITE-ON TECHNOLOGY CORP., TAIPEI (TW); LITE-ON ELECTRONICS (GUANGZHOU) LIMITED, GUANGZHOU (CN)

(21) Appl. No.: 13/755,284

(22) Filed: Jan. 31, 2013

(30) Foreign Application Priority Data
Mar. 28, 2012 (CN) 201210085990.4

(51) Int. Cl. G06F 3/02

(52) U.S. Cl. CPC G06F 3/02
USPC 341/22

(57) ABSTRACT

A scanning method for a keyboard includes steps (A), (B), (C) and (D). In step (A), a controller is configured to disable each column line from a respective first resistor and to disable each row line from a respective second resistor, and to send a scan signal to a column line. In step (B), the controller is configured to enable one of the row lines with the respective second resistor, and to read a signal on the row line. In step (C), the controller is configured to repeat step (B) with another one of the row lines until all row lines have been read. In step (D), the controller is configured to repeat steps (A), (B), and (C) with another one of the column lines until all column lines have been scanned.

### CROSS-REFERENCE TO RELATED APPLICATION

This application claims priority of Chinese application no. 201210085990.4, filed on Mar. 28, 2012, 2011.

### BACKGROUND OF THE INVENTION

1. Field of the Invention

The present invention relates to a method for keyboard scanning and a keyboard applying the same.

2. Description of the Related Art

In order to reduce the circuit impedance, the membrane keyboards in the consumer market use silver material of printing layer. However, the price of silver is rising, and therefore the industry is replacing silver with carbon, which is 20%-30% cheaper than silver, to manufacture membrane keyboards that use carbon printing to form membrane circuits.

Referring to FIG. 1, the circuit of a conventional membrane keyboard 1 includes a controller 11, a membrane circuit board 12 electrically connected with the controller 11, and a plurality of key switches 13. The membrane circuit board 12 includes a plurality of carbon-printed column lines (scanning line) P0.0-P0.7 and a plurality of carbon-printed row lines (return line) P1.0-P1.7 that are arranged in a matrix and intersect each other. The key switches 13 are respectively disposed at the intersections of the column lines P0.0-P0.7 and the row lines P1.0-P1.7. Each of the key switches 13 interconnects a corresponding one of the column lines P0.0-P0.7 and a corresponding one of the row lines P1.0-P1.7 when actuated. The controller 11 has a plurality of first resistors R1 and a plurality of switches (SW) that correspond respectively to the column lines P0.0-P0.7, and a plurality of second resistors R2 that correspond respectively to the row lines P1.0-P1.7. One terminal of each first resistor R1 electrically connects to a voltage source Vcc, and the other terminal of each first resistor R1 electrically connects to a corresponding one of the column lines P0.0-P0.7. One terminal of each switch SW electrically connects with a corresponding one of the column lines P0.0-P0.7, and the other terminal connects with ground. One terminal of each second resistor R2 connects with a corresponding one of the row lines P1.0-P1.7, and the other terminal connects with the voltage source Vcc.

There is a linear resistor R3 located between every pair of the key switches 13 on each of the column lines P0.0-P0.7, but the resistances of the resistors R3 are not necessarily the same. Similarly, there is a linear resistor R4 located between every pair of the key switches 13 on each of the row lines P1.0-P1.7, but the resistances of the resistors R4 are not necessarily the same. Since the column lines P0.0-P0.7 and row lines P1.0-P1.7 are made of carbon rather than silver, the resistances of the first and second resistors R1, R2 are higher, given that the resistance of carbon is higher than that of silver.

When scanning each of the column lines P0.0-P0.7, a scanning module 14 within the controller 11 will enable the switch SW corresponding to the column line being scanned in sequence. For instance, when scanning the column line P0.0, the column line P0.0 will be pulled to a low state while the other column lines P0.1-P0.7 remain in a high state, and then row lines P1.0-P1.7 will be sequentially read. During scanning, if a key switch 13 is actuated, such as key switch K11, then the column line P0.0 and the row line P1.0 will be elect ally connected to form an equivalent circuit as illustrated in FIG. 2.

Due to the stray capacitance C or capacitance inside controller 51, the linear resistor R4 electrically connected to the row line P1.0 and the second resistor R2 electrically connected to the row line P1.0 will affect the charge/discharge time (RC time) of the capacitor C. Therefore, the second resistor R2 electrically connected to the row line P1.0 will cause the RC time to increase, and the increase of RC time will cause a delay for the row line P1.0 to transition from a high to a low state, as illustrated by a falling time TD in FIG. 3. Similarly, when column line P0.0 returns to a high state after it has been scanned and the row line P1.0 is still electrically connected with the column line P0.0, the row line P.10 requires an extension in rising time TU before returning to a high state. In order to avoid the rising time TU and falling time TD associated with the row lines P1.0-P1.7, the scanning module 14 has to extend the length of scanning time for each column line P0.0-P0.7 so that the scanning times for the column lines do not overlap with the other. However, this decreases the efficiency of scanning, and failure to detect fast keystrokes might occur.

When only one key switch 13 is actuated, such as key switch K13 at the intersection of column line P0.2 and row line P1.0, as illustrated in FIG. 4, the scanning module 14 of the controller 11 can obtain a voltage signal V1 on the row line P1.0 as a result of voltage division. However, when multiple key switches, such as K11, K12 and K13, are actuated, causing row line P1.0 to electrically connect to the column lines P0.0, P0.1 and P0.2 simultaneously, the equivalent circuit when the column line P0.2 is being scanned is illustrated in FIG. 5. The voltage signal V1′ obtained from the equivalent circuit where key switches K11, K12 and K13 are actuated is different from the voltage signal V1 obtained from the equivalent circuit where only key switch K13 is actuated. The difference in voltage signal obtained is due to the actuation of key switches K11 and K12 that cause the column lines P0.0 and P0.1 and the first resistors R1 corresponding to the column lines P0.0 and P0.1 to electrically connect with the row line P1.0. Such difference can cause controller 14 to misinterpret the actuation of key switch K13 as an invalid one. Similarly, the case of multiple key switches 13 actuated on one column line produces the same problem as described above.

### SUMMARY OF THE INVENTION

The object of the present invention is to provide a scanning method for a keyboard that can increase scanning efficiency and avoid occurrence of errors.

According to one aspect of the present invention, there is provided a scanning method for a keyboard. The keyboard includes a controller, a plurality of column lines and row lines arranged in a matrix and intersecting each other, and a plurality of key switches respectively disposed at intersections of the column lines and the row lines. Each of the key switches interconnects a corresponding one of the column lines and a corresponding one of the row lines when actuated. Each of the column lines is connected with a first reference signal source through a respective first resistor. Each of the row lines is connected with the first reference signal source through a respective second resistor. The controller is configured to control connection between each of the column lines and the respective first resistor and between each of the row lines with the respective second resistor.

The scanning method comprises the steps of:

(A) configuring the controller to disconnect each of the column lines from the respective first resistor and to disconnect each of the row lines from the respective second resistor, followed by configuring the controller to send a scan signal to a column line to be scanned;

(B) configuring the controller to connect one of the row lines with the respective second resistor, to read a signal on said one of the row lines, and then to disconnect said one of the row lines from the respective second resistor;

(C) configuring the controller to repeat step (B) with another one of the row lines until the signals on all of the row lines have been read; and

(D) configuring the controller to repeat steps (A), (B), and (C) with another one of the column lines until all of the column lines have been scanned.

Another object of the present invention is to provide a keyboard that applies the scanning method of this invention.

According to another aspect of the present invention, a keyboard comprises:

a plurality of column lines and a plurality of row lines arranged in a matrix and intersecting each other;

a plurality of key switches respectively disposed at intersections of the plurality of column lines and the plurality of row lines, each of the key switches interconnecting a corresponding one of the column lines and a corresponding one of the row lines when actuated;

a plurality of first resistors corresponding respectively to the column lines, each of the first resistors having a terminal for connection to a first reference signal source;

a plurality of second resistors corresponding respectively to the row lines, each of the second resistors having a terminal for connection to the first reference signal source;

a plurality of first switches, each connected between a respective one of the column lines and one of the first resistors corresponding to the respective one of the column lines;

a plurality of second switches, each connected between a respective one of the column lines and a second reference signal source;

a plurality of third switches, each connected between a respective one of the row lines and one of the second resistors corresponding to the respective one of the row lines; and

a controller configured to disable the first and third switches prior to scanning one of the column lines, subsequently enable the second switch corresponding to one of the column lines to be scanned, enable the third switch corresponding to one of the row lines to be read, and disable the third switch after reading the one of the row lines.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic illustration of a membrane keyboard circuit according to the prior art;

FIG. 2 is an illustration of an equivalent circuit when the key switch K11 at the intersection of the column line P0.0 and the row line P1.0 of the membrane keyboard is actuated according to the prior art;

FIG. 3 is an illustration of state change when the column line P0.0 and the row line P1.0 of the membrane keyboard are electrically connected with each other according to the prior art;

FIG. 4 is an illustration of an equivalent circuit when the key switch K13 at the intersection of the column line P0.2 and the row line P1.0 of the membrane keyboard is actuated, and a reading of signal on the row line P1.0 when scanning the column line P0.2 according to the prior art;

FIG. 5 is an illustration of an equivalent circuit when key switches K11, K12 and K13 on the row line P1.0 of the membrane keyboard are simultaneously actuated, and a reading of signal on the row line P1.0 when scanning the column line P0.2 according to the prior art;

FIG. 6 is a schematic illustration of a keyboard according to the preferred embodiment of the present invention;

FIG. 7 is a flow chart of the scanning method for the keyboard according to the preferred embodiment of the present invention;

FIG. 8 is an illustration of an equivalent circuit when the key switch K11 at the intersection of the column line P0.0 and the row line P1.0 of the keyboard is actuated according to the preferred embodiment of the present invention; and

FIG. 9 is an illustration of an equivalent circuit when the key switch K11 at the intersection of the column line P0.0 and the row line P1.0 of the keyboard is actuated, and a reading of signal on the row line P1.0 when scanning the column line P0.0 according to the preferred embodiment of the present invention;

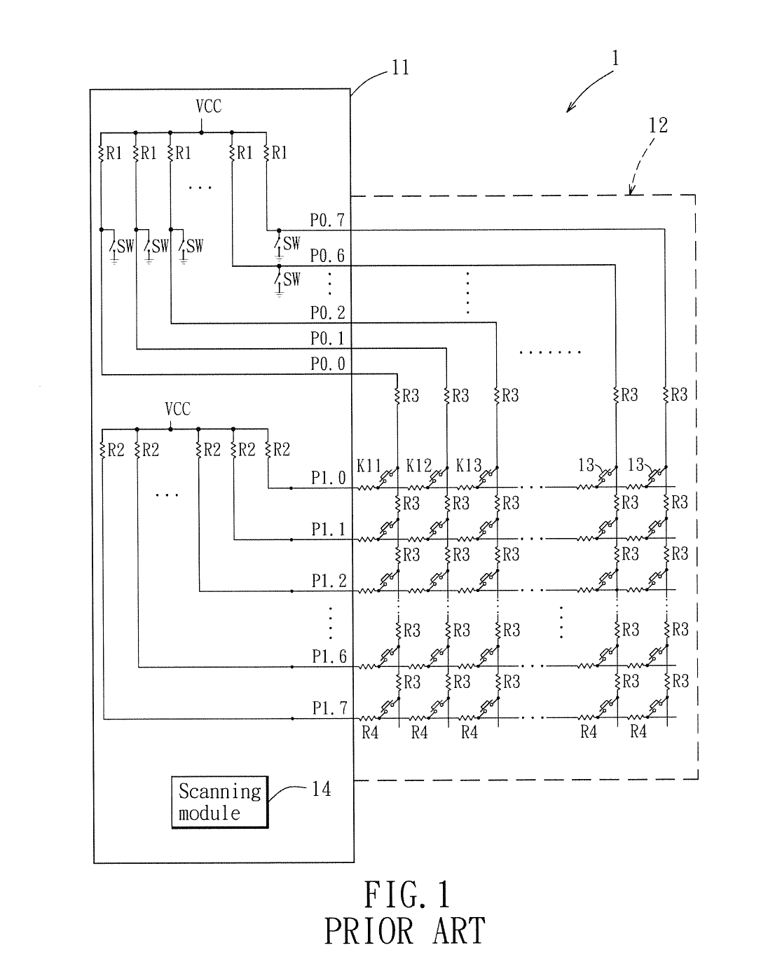

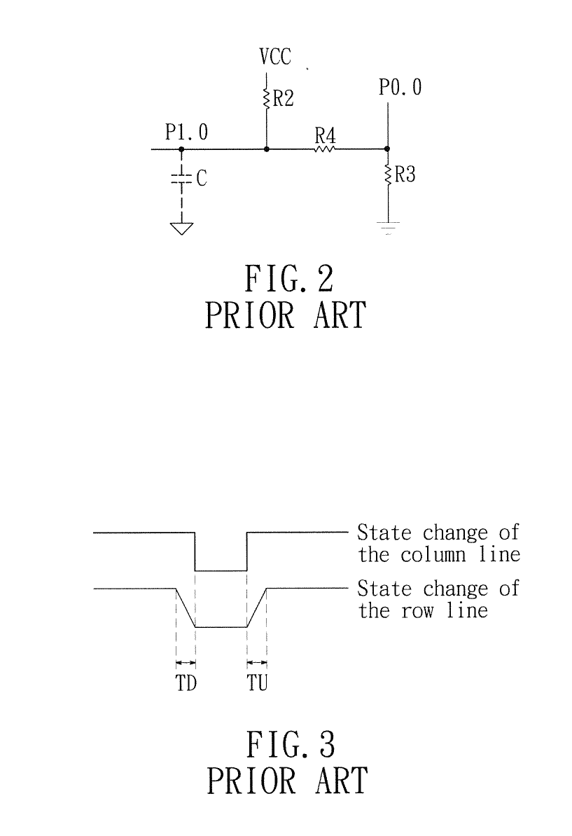

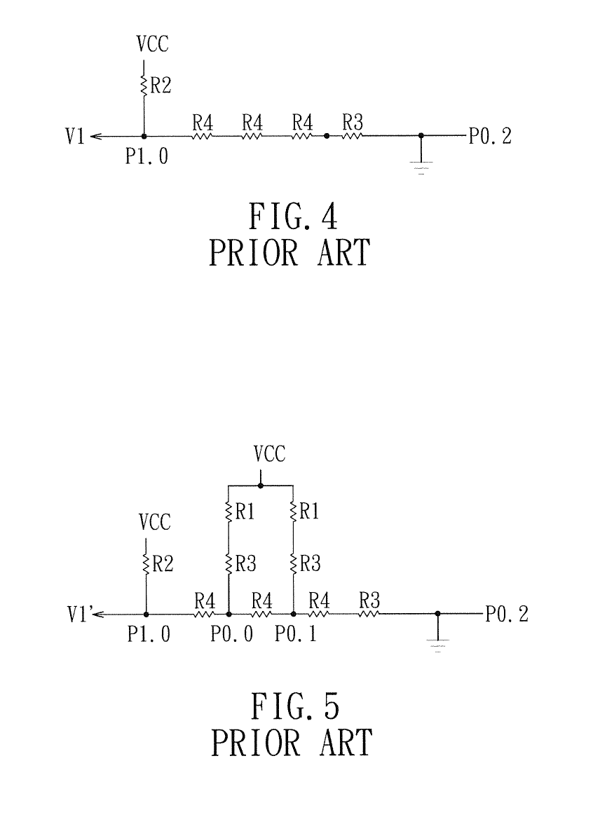

### DETAILED DESCRIPTION OF THE PREFERRED EMBODIMENT

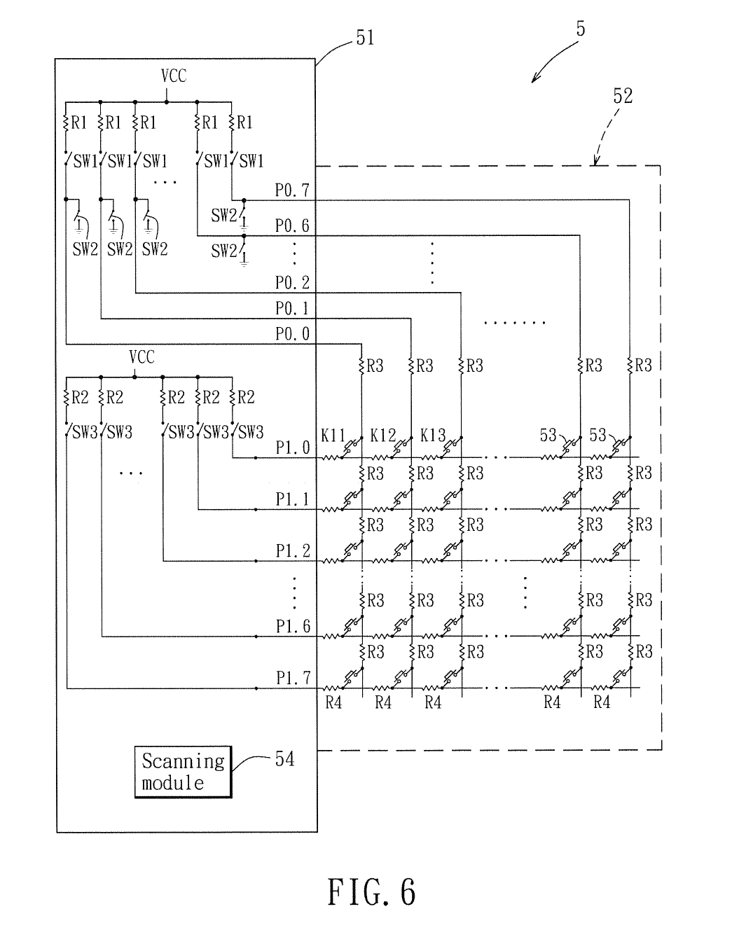

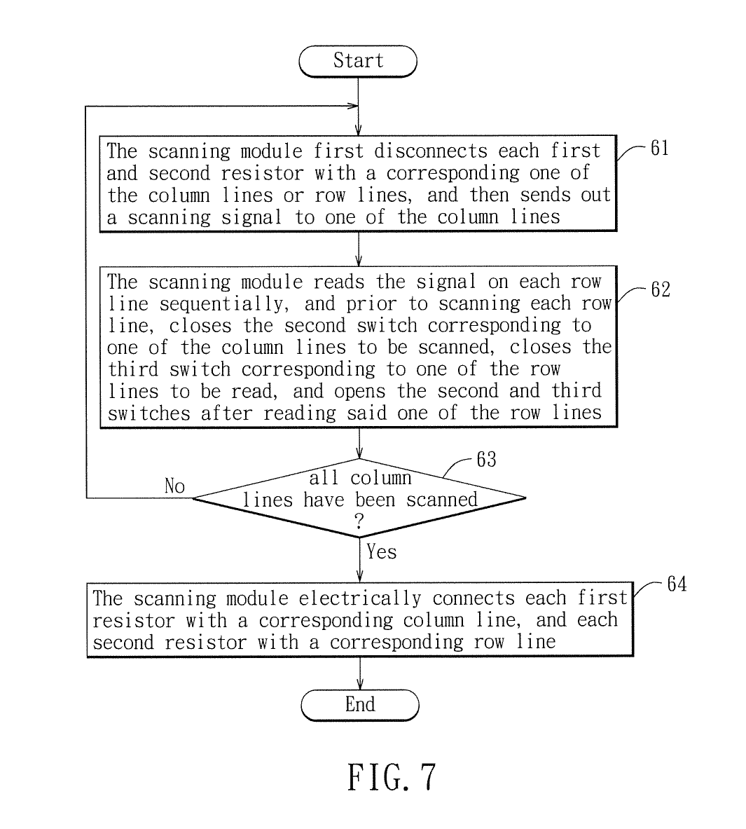

FIG. 6 illustrates a circuit of a preferred embodiment of the keyboard 5 of the present invention. The keyboard 5 can be a membrane keyboard but should not be limited thereto. FIG. 7 illustrates a preferred embodiment of the keyboard scanning method of the present invention, which can be applied to the membrane keyboard or a non-membrane keyboard having a similar circuit. Keyboard 5 includes a controller 51, a membrane circuit board 52 that is electrically coupled with the controller 51 and a plurality of key switches 53. The membrane circuit board 52 includes a plurality of carbon-printed column lines (scanning lines) P0.0-P0.7 and a plurality of carbon printed row lines (return lines) P1.0-P1.7 that form a matrix and intersect each other. The key switches 53 are respectively disposed at intersections of the column lines P0.0-P0.7 and the row lines P1.0-P1.7 to interconnect a corresponding one of the column lines and a corresponding one of the row lines when actuated.

The controller 51 includes a plurality of first resistors R1 corresponding respectively to the column lines P0.0-P0.7, a plurality of first switches SW1, a plurality of second switches SW2, as well as a plurality of second resistors R2 corresponding respectively to the row lines P1.0-P1.7 and a plurality of third switches SW3. Each of the first resistors R1 has a terminal electrically connected to a first reference signal source, such as a high reference signal voltage source Vcc, and another terminal electrically conducting with a corresponding one of the column lines P0.0-P0.7 through a corresponding one of the first switches SW1, as illustrated in FIG. 6. Each of the plurality of second switches SW2 has a terminal electrically connected to a respective one of the column lines P0.0-P0.7 and another terminal electrically connected to a second reference signal source, such as a low reference voltage source (ground). Each of the plurality of second resistors R2 has a terminal electrically connected to the first reference signal source and another terminal electrically conducting with a corresponding one of the row lines P1.0-P1.7 through a corresponding one of the third switches SW3.

A linear resistor R3 is electrically connected between any pair of the key switches 53 that are electrically connected to the same column line, and the resistances of the resistors R3 are not necessarily the same. Similarly, a linear resistor R4 is electrically connected between any pair of the key switches 53 that are electrically connected to the same row line, and the resistances of the resistors R4 are not necessarily the same.

The controller 51 controls the enabling and disabling of the first switches SW1, the second switches SW2 and the third switches SW3. Specifically, the controller 51 includes a scanning module 54 for detecting whether the key switches 53 are actuated. The scanning module 54 controls the enabling and disabling of the first switches SW1, the second switches SW2 and the third switches SW3 to carry out the scanning procedure of the key switches 53. That is, while sequentially scanning one of the column lines P0.0-P0.7, the scanning module will sequentially read for the signals on the respective row lines P1.0-P1.7 corresponding to the column line, in order to determine which of the key switches 53 has been actuated.

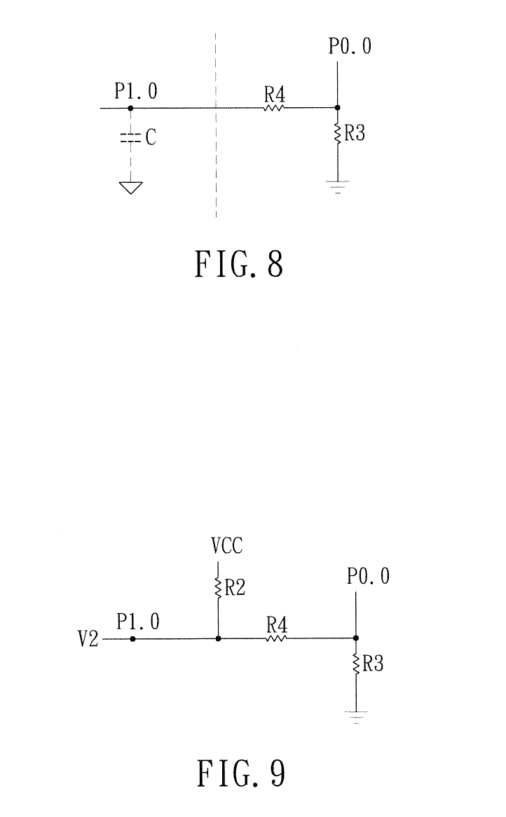

In the preferred embodiment of the scanning method for a keyboard, as illustrated in step 61 in FIG. 6, the first switches SW1, the second switches SW2 and the third switches SW3 are first disabled, causing each first resistor R1 to be disabled from the corresponding column line P0.0-0.7 (i.e., each first resistor R1 does not conduct with the corresponding column line P0.0-0.7) and each second resistor R2 to be disabled from the corresponding row line P1.0-1.7, and a scanning signal is subsequently sent to enable the second switch SW2 corresponding to the column line that is to be scanned. For example, when scanning the column line P0.0, the second switch SW2 corresponding to the column line P0.0 is enabled, conducting column line P0.0 with the second reference signal source (ground). During this time, if the key switch K11 at the intersection of column line P0.0 and row line P1.0 is actuated, the equivalent circuit will be that illustrated in FIG. 8. Due to the disabling of the row line P1.0 from the second resistor R2 corresponding to the row line P1.0,the RC time constant of charging or discharging of the internal capacitor C of the controller 51 (and/or other stray capacitance is shortened. Therefore, the row line P1.0 is able to transition to the low state as soon as the row line P1.0 is electrically connected with the column line P0.0 which is in a low state, reducing the falling time TD (see FIG. 3) required for a row line to reach a low state. By such virtue, the time for scanning each column line can be effectively reduced and detection of keystrokes during high speed typing can be enhanced.

Subsequently, in step 62, the scanning module 54 sequentially read the signal on each of the row lines P1.0-P1.7. For example, before reading the row line P1.0, the third switch SW3 corresponding to the row line P1.0 is enabled to enable the row line P1.0 with the respective second resistor R2 for reading the voltage signal V2 on row line P1.0 derived from voltage division. According to the voltage signal V2, it can be determined whether the key switch K11 has been actuated. After reading the voltage signal on row line P1.0, the third switch SW3 corresponding to the row line P.0 is disabled, disabling the row line P1.0 from the respective second resistor R2. Repeatedly, the next row line is read in the above manner until all the row lines P1.0-P1.7 are read.

When multiple key switches 53 are actuated at the same time, such as the simultaneous actuation of three key switches K11, K12 and K13 at the intersections of row line P1.0 and column lines P0.0, P0.1 and P0.2, and when the column line P0.2 is being scanned, both the linear resistors R3 and the first resistors R1 corresponding to the column lines P0.1 and P0.2 are left floating electrically since the first switches SW1 corresponding to the column lines P0.1 and P0.2 are disabled. As illustrated in FIG. 9, the equivalent circuit at this instance is the same as the equivalent circuit when only key switch K13 is actuated. Therefore, when scanning column line P0.2, the voltage signal on row line P1.0 where multiple key switches K11, K12 and K13 on the same row line P1.0 are actuated is the same as the voltage signal when only key switch K13 is actuated. This prevents false readings by the controller 51 when multiple key switches on the same row line are actuated. Similarly, the same prevention can apply when multiple key switches on a column line are simultaneously actuated.

In step 63, the scanning module 54 determines whether all column lines P0.0-P0.7 have been scanned. If any of the column lines P0.0-P0.7 has not been scanned, repeat steps 61 and 62 are repeated until all column lines P0.0-P0.7 have been scanned. When all column lines P0.0-P0.7 have been scanned, the flow goes to step 64, in which all of the first switches SW1 and third switches SW3 are enabled so that all of the column lines P0.0-P0.7 and row lines P1.0-P1.7 are restored to a high state. This prevents some column lines or row lines from residing in a low state that may result in false readings when a scan is being performed.

Furthermore, to ensure accuracy of the scanning results, the scanning module 54 can repeat the scanning procedures in FIG. 7 two to three times to ensure that the key switches 53 deemed actuated are indeed actuated.

In summary, before scanning the column lines P0.0-P0.7, the scanning module 59 of the controller 51 disables all the first resistors R1 from the column lines P0.0-P0.7 corresponding to the first resistors R1, and disables all the second resistors R2 from the row lines P1.0-P1.7 corresponding to the second resistors R2, and then sequentially scans each of the column lines P0.0-P0.7. When a key switch 53is being pressed, the falling time (TD) that it takes for any row line that is connected to the column line being scanned to change state from high to low is reduced, i.e., the scanning duration may be reduced, and therefore the scanning efficiency may be increased. This prevents the problem of not detecting all the keystrokes during high-speed typing due to the long scanning duration, as encountered in the prior art. Further, the scanning module 54, by sequentially reading the row lines when scanning each column line and only electrically enabling the row line that is to be read with the corresponding second resistor R2, is able to correctly detect multiple key switches 53 that are actuated simultaneously.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A scanning method for a keyboard, the keyboard including a controller, a plurality of column lines and row lines arranged in a matrix and intersecting each other, and a plurality of key switches respectively disposed at intersections of the column lines and the row lines,
each of the key switches interconnecting a corresponding one of the column lines and a corresponding one of the row lines when actuated,
each of the column lines being connected with a first reference signal source through a respective first resistor,
each of the row lines being connected with the first reference signal source through a respective second resistor,
the controller being configured to control connection between each of the column lines and the respective first resistor and between each of the row lines with the respective second resistor,
said scanning method comprising the steps of:
(A) configuring the controller to disable each of the column lines from the respective first resistor and to disable each of the row lines from the respective second resistor, followed by configuring the controller to send a scan signal to a column line to be scanned;
(B) configuring the controller to enable one of the row lines with the respective second resistor, to read a signal on said one of the row lines, and then to disable said one of the row lines from the respective second resistor;
(C) configuring the controller to repeat step (B) with another one of the row lines until the signals on all of the row lines have been read; and
(D) configuring the controller to repeat steps (A), (B), and (C) with another one of the column lines until all of the column lines have been scanned.

2. The scanning method as claimed in claim 1, wherein the controller has a scanning module that is configured to perform steps (A), (B), (C) and (D). 15

3. The scanning method as claimed in claim 1, wherein, in step (A), the scan signal is for causing the column line to be scanned to be enabled with a second reference signal source.

4. The scanning method as claimed in claim 1, further comprising, after step (D):
configuring the controller to enable each of the column lines with the respective first resistor and to enable each of the row lines with the respective second resistor.

5. The scanning method as claimed in claim 1, wherein the first reference signal source is a high reference signal source and the second reference signal is a low reference signal source.

6. A keyboard, comprising:
a plurality of column lines and a plurality of row lines arranged in a matrix and intersecting each other;
a plurality of key switches respectively disposed at intersections of the plurality of column lines and the plurality of row lines, each of said key switches interconnecting a corresponding one of said column lines and a corresponding one of said row lines when actuated;
a plurality of first resistors corresponding respectively to said column lines, each of said first resistors having a terminal for connection to a first reference signal source;
a plurality of second resistors corresponding respectively to said row lines, each of said second resistors having a terminal for connection to the first reference signal source;
a plurality of first switches, each connected between a respective one of said column lines and one of said first resistors corresponding to the respective one of said column lines;
a plurality of second switches, each connected between a respective one of said column lines and a second reference signal source;
a plurality of third switches, each connected between a respective one of said row lines and one of said second resistors corresponding to the respective one of said row lines; and
a controller configured to disable said first and third switches prior to scanning one of said column lines, subsequently enabled said second switch corresponding to one of the column lines to be scanned, enabled said third switch corresponding to one of the row lines to be read, and disabled said third switch after reading said one of the row lines.

7. The keyboard as claimed in claim 6, wherein said controller is configured to read said row lines in sequence when scanning one of said column lines, and is configured to scan said column lines in sequence until all of said column lines have been scanned.

8. The keyboard as claimed in claim 7, wherein said controller includes a scanning module to implement scanning of said column lines and reading of said row lines.

9. The keyboard as claimed in claim 6, wherein said first and second resistors and said first, second and third switches are built into said controller.

10. The keyboard as claimed in claims 7, wherein said controller is configured to enable said first switches and said third switches after all of said column lines have been scanned.

11. The keyboard as claimed in claim 6, which is a membrane keyboard.

12. The keyboard as claimed in claim 6, wherein said controller is configured to disable said second switch corresponding to one of said column lines after said one of said column lines has been scanned.
